(19) United States
(12) Patent Application Publication
(10) Pub. No.: US 2012/0019947 A1
(43) Pub. Date: Jan. 26, 2012

(54) TECHNIQUE FOR PROGRAMMABLE RISE TIME IN HARD DISK DRIVE WRITER

(75) Inventors: Jeremy Robert Kuehlwein, Woodbury, MN (US); Marius Vicentiu Dina, Inver Grove Heights, MN (US)

(73) Assignee: Texas Instruments Incorporated, Dallas, TX (US)

(21) Appl. No.: 12/842,995

(22) Filed: Jul. 23, 2010

(51) Int. Cl. G11B 19/02; G11B 5/09

(52) U.S. Cl. 360/46; 360/69; G9B/19.001

(57) ABSTRACT

A write channel for a hard disk drive has a write current with a programmably adjustable rise time, and includes first and second analog write data signal paths having respective resistive nodes. First and second programmable capacitors are connected to the resistive nodes, whereby changes in capacitance of the first and second capacitors changes the rise time of the write current. A programmer selectively programs the first and second programmable capacitors. The rise time programmed is selected to provide a decreased bit error rate of an on-track write process and reduced adjacent-track interference.

### BACKGROUND

1. Field

This various circuit embodiments described herein relate in general to improvements in mass data storage devices, and, more specifically, to improvements in the write data signal path in hard disk drives, and still more specifically to improvements in methods and apparatuses for programmably controlling the rise time of write currents in hard disk drives, and the like.

2. Background

Hard disk drive suppliers are constantly battling adjacent-track interference, which is a condition in which tracks adjacent (herein the “adjacent-tracks”) to the track being written (herein the “on-track”) are corrupted due to the magnetic flux from the write operation spilling over into the adjacent-tracks. This condition becomes worse with faster rise times and is lessened with slower rise times of the preamplifier writer in the write data signal path. However, the bit error rate (BER) for the on-track is usually improved when the write current has a faster rise time. Consequently, in the design of hard disk drives, a tradeoff is often made between the improved BER of faster rise times and the reduced adjacent-track interference produced by slower rise times to find a suitable rise time to design into the write data signal path of the hard disk drive.

In the past, design of the components in the write data signal path has involved reducing the current in critical performance locations in order to slow down the rise time. In the past, one technique that has been used to reduce the current in the write data signal path has been to reduce the current in the buffering stages, such as emitter followers or class AB drivers, in the write data signal path. However, a wider range of possible rise times is desired than is possible with this approach.

Although reducing the current in the write data signal path may save power, there are some problems with this approach. One problem is that the range of possible rise times is limited, regardless of the location chosen in the write data signal path. Another problem is that reducing current in the write data signal path can have performance implications. This can range from signal integrity degradation, such as increased jitter, which ultimately affects BER, to missing write data pulses if the current is completely starved under certain write data patterns or process conditions. This is especially true if the current reduction results in reduced signal swing.

What is needed is an ability to programmably adjust the rise time of the write current in order to find and set the best tradeoff between on-track BER and adjacent-track interference.

### SUMMARY

According to one embodiment described herein, a hard disk drive includes a write channel for providing a write current to a write head of the hard disk drive. The write channel has first and second analog write data signal paths, each having respective resistive nodes. First and second programmable capacitors are connected to the resistive nodes, whereby changes in capacitance of the first and second capacitors changes a rise time of the write current. A programmer selectively programs the first and second programmable capacitors.

According to another embodiment described herein, a write channel for a hard disk drive has a write current with a programmably adjustable rise time. The write stage has first and second analog write data signal paths having respective resistive nodes. First and second programmable capacitors are connected to the resistive nodes whereby changes in capacitance of the first and second programmable capacitors change the rise time of the write current. A programmer selectively programs the first and second programmable capacitors.

According to yet another embodiment described herein, a method for programmably adjusting a rise time of a write current in a write stage of a hard disk drive includes providing programmable capacitors at resistive nodes in an analog portion of a write channel of a hard disk drive, and programming the programmable capacitors to adjust the rise time of the write current. The particular rise time that is programmed is selected by determining a rise time that provides a decreased bit error rate of an on-track write process and reduced adjacent-track interference.

Slowing down the rise time is achieved by adding a programmable pole, for example, by adding programmable capacitors, at resistive nodes in the write data signal path, rather than by reducing current in the write data signal path. By adding the programmable capacitors, a wider range of programmable rise times can be achieved. Since there is no reduction in the currents in the write data signal path, performance is not degraded beyond that which a slower rise time itself causes. Additionally, the programmable rise time is implemented after the analog signal has already been created.

### BRIEF DESCRIPTION OF THE DRAWINGS

FIG. 1 is an electrical schematic and block diagram of a portion of a write channel circuit in a hard disk drive system, according to an embodiment of the present invention.

FIG. 2 is an electrical schematic diagram of an embodiment of a programmable capacitance that can be used in the circuit of FIG. 1.

FIG. 3 is a graph of current vs. time, showing a simulation of the operation of the circuit of FIG. 1, illustrating an example the programmable rise time variations that can be achieved.

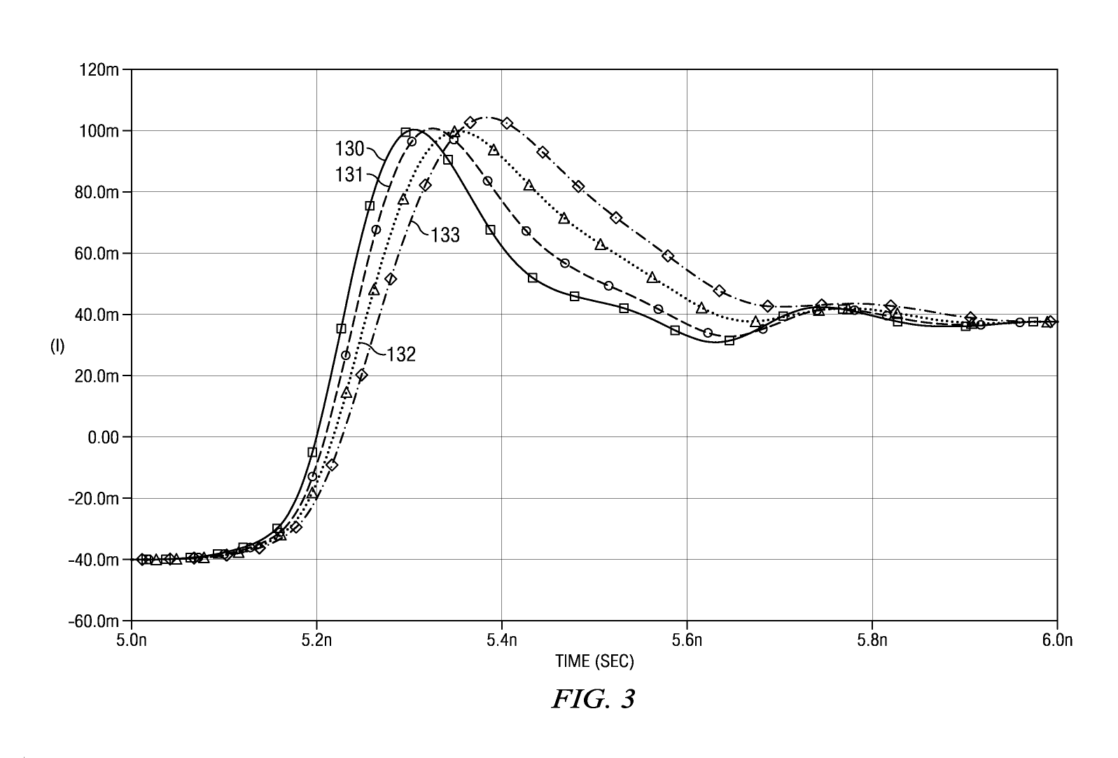

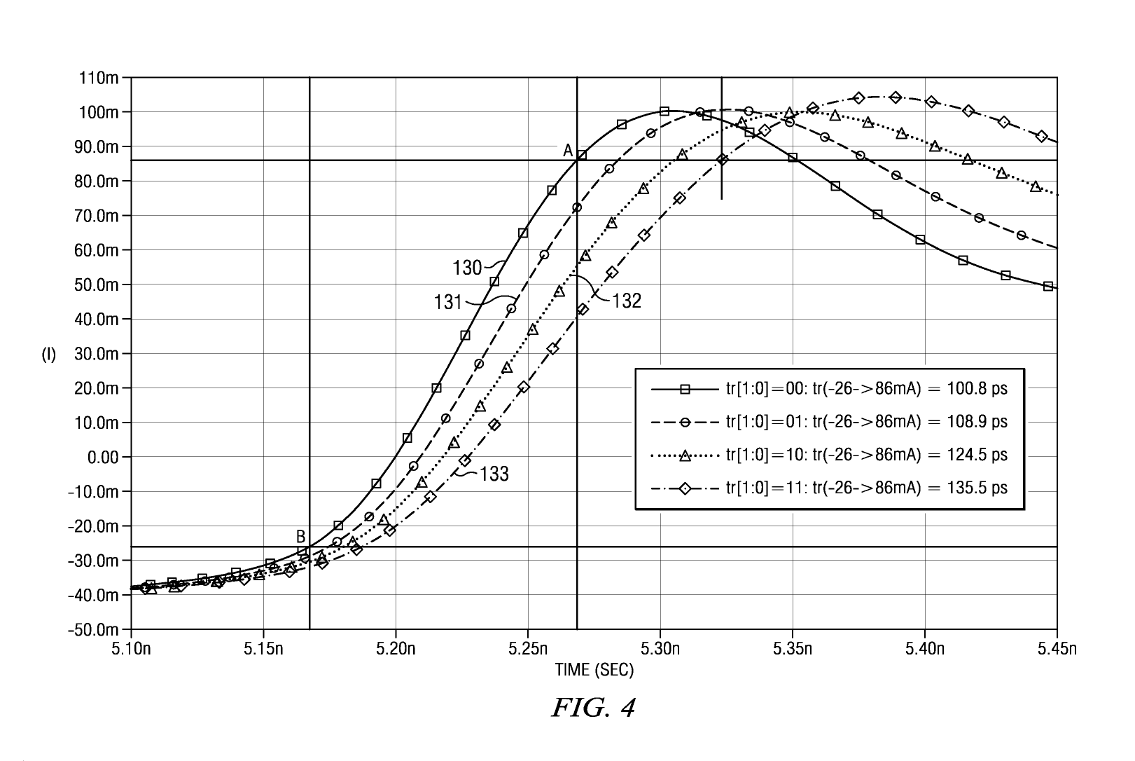

And FIG. 4 is the graph of current vs. time of FIG. 3, having an expanded time scale for further illustration of the programmable rise time variations that can be achieved.

In the various figures of the drawing, like reference numbers are used to denote like or similar parts.

### DETAILED DESCRIPTION

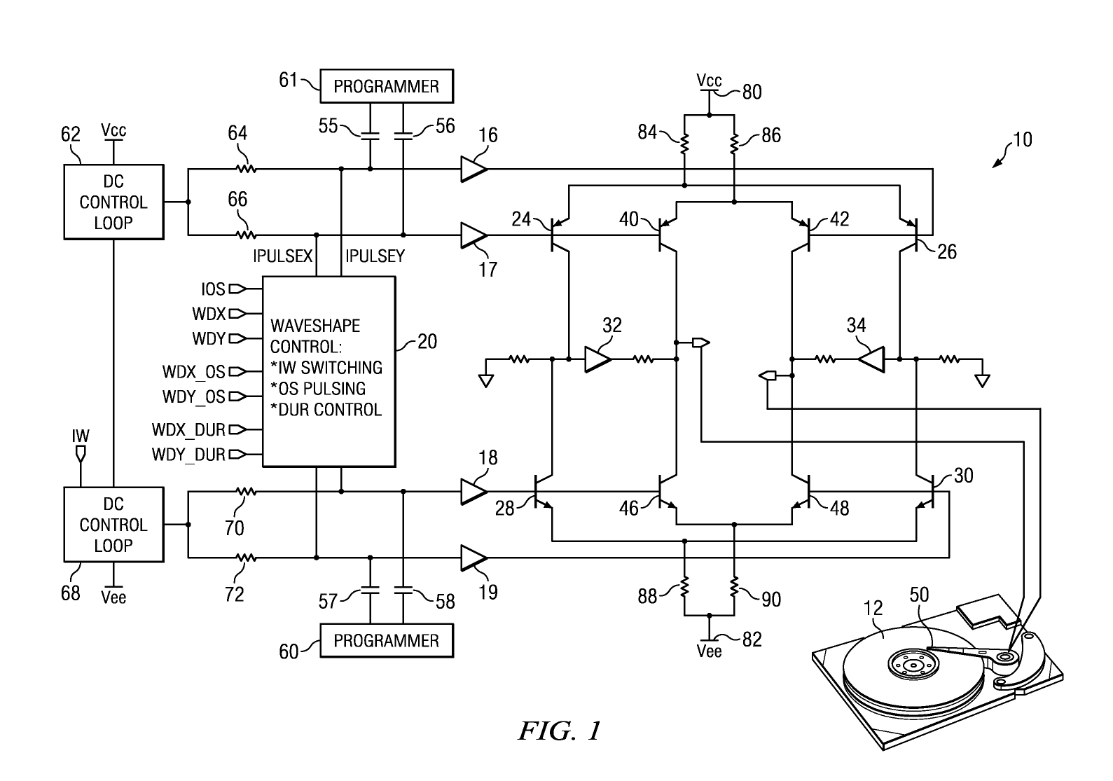

Reference is now made to FIG. 1, which shows a simplified electrical schematic and block diagram of a portion of a write channel circuit 10 for a hard disk drive 12, according to an embodiment of the present invention. The write channel circuit 10 provides write currents to the write head 50 of the hard disk drive 12 having one or more rotating disks having magnetic media to which data may be written or from which the data may be read. Although only one write head 50 is shown, it is understood that a plurality of write heads may be employed.

Programmable write current rise time is achieved by adding a programmable pole in both top and bottom signal paths, after the analog signal is created. This is achieved by adding programmable capacitance to a resistive node. This provides a large range of programmable rise time, as may be desired by the customer. By virtue of this technique, current need not be reduced in the write data signal path, so there is no performance degradation beyond that due to the rise time slowdown itself.

The write channel circuit 10 includes input preamplifier drivers 16-19 which receive analog input signals from a wave shaping control circuit 20. The input preamplifier drivers 16-19 provide outputs to differential transistor pairs 24-26, 40-42, 28-30, and 46-48. An output driver amplifier 32 is connected between the collectors of transistors 24 and 26 and the collectors of transistors 40 and 46. In like manner, an output driver amplifier 34 is connected between the collectors of transistors 26 and 30 and the collectors of transistors 42 and 48.

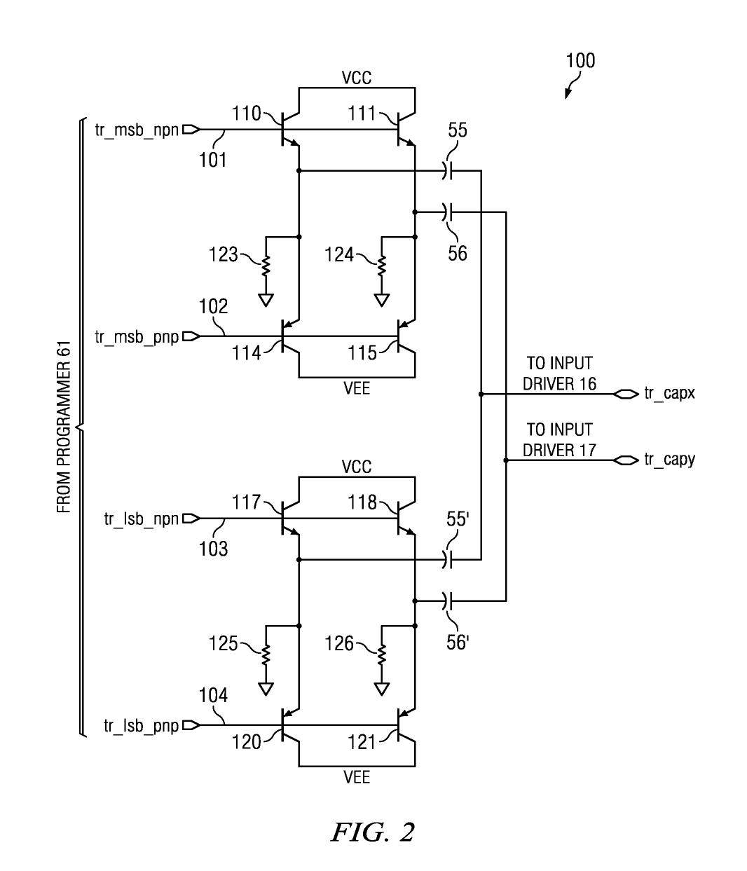

The differential transistor pairs 24-26, 40-42, 28-30, and 46-48 provide write data signals to a write head 50 of the hard disk drive 12. Programmable capacitive elements are provided by sets of programmable capacitors 55-56, connected at the input nodes of the input preamplifier drivers 16-17 and programmable capacitors 57-58 connected at the input nodes of the input preamplifier drivers 18-19, to provide poles thereat. The programmable capacitors 55-56 are programmed by a programmer 61, and the programmable capacitors 57 and 58 are programmed by a programmer 60, in a manner described below. It should be noted that although only one capacitor element is illustrated to represent each of the programmable capacitors 55-58, each of the programmable capacitors 55-58 may be implemented with a plurality of capacitors that are programmably controlled to provide a desired programmed capacitance, as described below in greater detail with reference to FIG. 2.

More particularly, the respective inputs to the input preamplifier drivers 16-17 are connected to a DC control loop 62 by resistors 64 and 66, and the respective inputs to the input preamplifier drivers 18-19 are connected to a DC control loop 68 by resistors 70-72. The resistors 64, 66, 70, and 72 provide a resistive input node to the input preamplifier drivers 16-19 to which the respective programmable capacitors 55-58 are connected.

An electrical schematic diagram of an example embodiment of a capacitor circuit 100 by which a programmable capacitance can be provided is shown in FIG. 2, to which reference is now additionally made. Although only one programmable capacitance circuit is shown, it should be understood that two circuits of the type illustrated in FIG. 2 may be instantiated in the implementation of the write stage circuit 10 of FIG. 1, one on the topside to provide programmable capacitors 55 and 56, and the other on the bottom side to provide programmable capacitors 57 and 58.

Digital programming signals (tr_msb_npn, tr_msb_pnp, tr_lsb_npn, and tr_lsb_pnp) from the programmer 61 are applied to programming lines 101-104 to control respective bipolar junction transistor pairs 110-111, 114-115, 117-118, and 120-121, which are connected between positive (Vcc) and negative (Vee) supply voltages, to ground by resistors 123-126, as shown. Four capacitors 55, 56, 55′, and 56′ are connected to the emitters of the bipolar junction transistors; more particularly, capacitor 55 is connected to the emitters of transistors 110 and 114, capacitor 56 is connected to the emitters of transistors 111 and 115, capacitor 55′ is connected to the emitters of transistors 117 and 120, and capacitor 56′ is connected to the emitters of transistors 118 and 121. As suggested above, programmable capacitor 55 shown in FIG. 1 is provided by capacitors 55 and 55′ in the capacitor circuit 100, and programmable capacitor 56 is provided by capacitors 56 and 56′.

Thus, the program signals on input lines 101-104 selectively connect the capacitors 55, 56, and 55′,56′ between either the positive supply (Vcc) or negative (Vee) supply lines and ground to enable the capacitors 55, 56, 55′, and 56′ to be interconnected in various combinations to vary the amount of capacitance provided to the write stage circuit 10 at the inputs to the input drivers 16 and 17. Note that the implementation of the capacitor circuit 100 shown in FIG. 2 provides two bits of programmable capacitance; however, the capacitor circuit 100 can be readily modified to increase or decrease the number of stages to have any arbitrary number of programmable bits. A similar example embodiment of a circuit by which a programmable capacitance can be provided is shown in U.S. Pat. No. 6,696,896 assigned to the assignee hereof and incorporated herein by reference in its entirely.

The circuits of programmers 60 and 61 may be any circuit that can produce control signal that programmably interact with the particular programmable capacitors that are implemented. For example, if the programmable capacitors 55-58 are of the type that change capacitance in response to increasing digital input steps, the programmer 61 may be a counter, or the like that can produce appropriate combinations of output signals to the capacitors 55-58. Of course any number of capacitors can be used and any number of programmable steps can be used, depending on the resolution to be achieved and number of rise time adjustments desired to be made, with appropriate counting or control signal provisions from the programmer 61. Similar considerations apply as well to the circuitry of programmer 60.

In operation, drive currents may be switchably applied to the write head 50 between positive and negative supply voltages 80 and 82 through degeneration resistors 84 and 86 and degeneration resistors 88 and 90, respectively. The drive currents to the differential transistor pairs 40, 42 and 46, 48 are provided by the input preamplifier drivers 16-20. Although some rise time wave shaping can be accomplished by the wave-shape controller 20, where the analog waveform is created from multiple sets of digital data, reducing current in the wave-shape controller poses an additional risk of altering the analog wave-shape. Thus, it is safer to slow down the edge (rise time) after the analog signal is already formed at resistors 64, 66, 70, and 72; moreover, the rise time of the drive current can be more precisely controlled by programming the capacitors 55-58 via programmer 60.

The value of the particular programmable capacitances 55-58 may be determined by the range of programmable rise time desired, the bandwidth of the entire system, and the value of resistance at which the programmable capacitance is placed. These parameters will vary depending on the application. The AC ground is provided by an AB driver output, only the slave of the AB driver being shown in FIG. 1. The master of the AB driver is located in another cell (not shown) that can be shared amongst top and bottom programmable capacitance cells, but must be separated by bit since each bit can be turned on or off independently. When a particular bit is turned off, the output of the AB driver is reversed biased to provide low parasitic capacitance.

FIG. 3, to which reference is now additionally made, is a graph of current vs. time, illustrating the operation of the circuit of FIG. 1 and illustrating an example of the programmable rise time variations 130-133 that can be achieved. FIG. 4, to which reference is also made, shows an expanded view of the graphs of FIG. 3, illustrating the rising edge (rise time) progressively slowing down as the tr bits (programmable rise time bits shown in FIG. 2) are increased from 00 to 11.

It should be noted that it is desirable to keep the write current overshoot amplitude the same, for example ˜100 mA illustrated in FIG. 4, regardless of the programmable rise time setting. This may be achieved by prolonging the timing between the digital signal inputs to the wave-shape controller 20 in FIG. 1 to compensate for the longer rise times. If desired, this timing may be programmable, using the same or similar programmable rise time bits and programmable capacitors (not shown) to provide the best compensation over varying process conditions.

Electrical connections, couplings, and connections have been described with respect to various devices or elements. The connections and couplings may be direct or indirect. A connection between a first and second electrical device may be a direct electrical connection or may be an indirect electrical connection. An indirect electrical connection may include interposed elements that may process the signals from the first electrical device to the second electrical device.

Additionally, it will be appreciated that many of the circuit elements disclosed herein are of particular types, for example, bipolar junction transistors of certain conductivities (for example, npn or pnp). It will be understood that other transistor types and other transistor conductivities may be equally advantageously employed with appropriate circuit or supply voltage changes.

Although the invention has been described and illustrated with a certain degree of particularity, it should be understood that the present disclosure has been made by way of example only, and that numerous changes in the combination and arrangement of parts may be resorted to without departing from the spirit and scope of the invention, as hereinafter claimed.

1. A write channel for a hard disk drive having a write current with a programmably adjustable rise time, comprising:
first and second analog write data signal paths having respective resistive nodes;
first and second programmable capacitive elements connected to the resistive nodes whereby changes in capacitance of the first and second capacitive elements change the rise time of the write current;
a programmer for selectively programming the first and second programmable capacitive elements.

2. The write channel of claim 1,
wherein each of said write data signal paths comprise a pair of data lines to conduct write data signals,
further comprising first and second differential transistor pairs to provide the write current to a write head of the hard disk drive, wherein write data signals conducted by the pairs of data lines control a respective one of the first and second differential transistor pairs to provide the write current,
and wherein the programmable capacitive elements comprise first and second pairs of programmable capacitors connected to a respective pair of the data lines.

3. The write channel of claim 2 wherein the first and second programmable capacitors are connected at one side to respective resistive nodes and selectively connectable to ground at another side, and wherein said programmer selectively connects another side of the programmable capacitors to ground to programmably adjust the capacitance provided by the programmable capacitors.

4. The write channel of claim 1 further comprising a wave-shape controller having a digital signal input and an analog signal output for shaping the write current, wherein the resistive nodes are between the wave-shape controller and a write head.

5. The write channel of claim 2 further comprising input preamplifier drivers to receive the output of a wave-shape controller, and wherein the resistive nodes are located at the inputs to the input preamplifier drivers.

6. The write channel of claim 1 wherein the write channel comprises differential transistor pairs on opposite sides of a write head that can be driven to provide currents in opposite directions therein and a pair of input preamplifier drivers on each side of the write head to provide control currents to the differential transistor pairs;
and wherein the programmable capacitive elements comprise first and second pairs of capacitors connected at respective inputs of input preamplifier drivers.

7. The write channel of claim 6 wherein the differential transistor pairs are bipolar junction transistors.

8. A method for programmably adjusting a rise time of a write current in a write stage of a hard disk drive, comprising:
providing capacitive elements having programmable capacitances to resistive nodes in an analog portion of a write channel of the write stage;
programming the programmable capacitances of the capacitive elements to programmably adjust the rise time of the write current.

9. The method of claim 8 wherein the programming comprises selecting a rise time that provides a decreased bit error rate of an on-track write process and a reduced adjacent-track interference.

10. The method of claim 8 wherein said providing capacitive elements comprises providing programmable capacitors connected at one side to respective resistive nodes and selectively connectable to ground at another side, and wherein said programming comprises selectively connecting the capacitors to ground to programmably adjust the capacitance provided by the capacitors.

11. The method of claim 8 further comprising maintaining a write current overshoot amplitude substantially the same for each programmed rise times.

12. The method of claim 8 further comprising providing wave shaping to a write data signal in a portion of the write channel prior to the resistive nodes.

13. A hard disk drive, comprising:
a write channel for providing a write current to a write head of the hard disk drive;
the write channel comprising first and second analog write data signal paths having respective resistive nodes;
first and second programmable capacitive elements connected to the resistive nodes, whereby changes in capacitance of the first and second capacitive elements changes a rise time of the write current;
and a programmer for selectively programming the first and second programmable capacitive elements.

14. The hard disk drive of claim 13,
wherein each of said write data signal paths comprise a pair of data lines to conduct write data signals,
further comprising first and second differential transistor pairs to provide the write current to a write head of the hard disk drive, wherein write data signals conducted by the pairs of data lines control a respective one of the first and second differential transistor pairs to provide the write current,
and wherein the programmable capacitive elements comprise first and second pairs of programmable capacitors connected to a respective pair of the data lines.

15. The hard disk drive of claim 14 wherein the first and second pairs of programmable capacitors are connected at one side to respective resistive nodes and are selectively connectable to ground at another side, and wherein said programmer selectively connects the another side of the programmable capacitors to ground to programmably adjust the capacitance provided by the programmable capacitors.

16. The hard disk drive of claim 13 further comprising a wave-shape controller for shaping the write current, wherein the resistive nodes are between the wave-shape controller and the write head.

17. The hard disk drive of claim 13 wherein the write channel comprises differential transistor pairs on opposite sides of a write head that can be driven to provide currents in opposite directions therein and a pair of preamplifier driver amplifiers on each side of the write head to provide control currents to the differential transistor pairs;
and wherein the programmable capacitive elements comprise first and second pairs of capacitors connected at respective inputs of the preamplifier driver amplifiers.

18. The hard disk drive of claim 17 wherein the differential transistor pairs are bipolar junction transistors.

19. The hard disk drive of claim 13 wherein the programming comprises selecting a rise time that provides a decreased bit error rate of an on-track write process and reduced adjacent-track interference.

20. The hard disk drive of claim 13 further comprising input preamplifier drivers to receive the output of the wave-shape controller, and wherein the resistive nodes are located at the inputs to the input preamplifier drivers.
